(19) United States
(12) Patent Application Publication
(10) Pub. No.: US 2002/0029217 A1
(43) Pub. Date: Mar. 7, 2002

(54) Telephone number inquiry method and database for all residents

(75) Inventor: Richard Huang, Hsinchu (TW)

Correspondence Address: LADAS & PARRY, 26 WEST 61ST STREET, NEW YORK, NY, 10023, US

(73) Assignee: RAYCAM SYSTEM TECHNOLOGY

(21) Appl. No.: 09/978,641

(22) Filed: Oct. 16, 2001

Related U.S. Application Data
(63) Continuation-in-part of application No. 09/633,757, filed on Aug. 7, 2000.

(30) Foreign Application Priority Data
Aug. 9, 1999 (TW) 88113583
Oct. 16, 2000 (TW) 88113583A01

(51) Int. Cl. G06F 7/00

(52) U.S. Cl. 707/100

(57) ABSTRACT

The present invention relates to a telephone number inquiry method and a database for all residents. A main feature of the present invention is that a third name belonging to a second object is introduced in a first object of the database. The third name is for recording employer's name or superior company name which can therefore be inquired through the telephone number inquiry of a related third party other than the holder of the telephone (number) record. Furthermore, based on the third name of known employer's name or superior company name, a colleague of the third party or related company name can also be inquired. Various ways of accomplishing the objectives of telephone number inquiry for all residents are provided.

### BACKGROUND OF THE INVENTION

1. Field of the Invention

The present invention relates to a telephone number inquiry method and a database for all residents, more particularly to a telephone number inquiry method and a database by which further inquiries concerning the names of either the employer or the superior company of a relevant third party other than the holder of the telephone (number) record can be made. In addition, the names of associates or affiliated companies of the specific third party can also be inquired through the inquiry of the third party's employer or superior company.

2. Description of Related Art

The present invention is an improvement on the U.S. application Ser. No. 09/633,757 (hereinafter referred to as the “parent application”), a telephone number inquiry method and a database for all residents, whose disclosure is incorporated in the present invention. The parent application discloses a database including a plurality of first objects, each of which further comprises a plurality of second objects. Each first object can include second objects such as telephone number, name serial number, first name, second name, extension or other relevant information.

However, although the parent application has disclosed that any third party that shares the same telephone number can be inquired, the third party is only mentioned in the second name in the embodiment. The present invention finds improved utility when a third name is added. Hence, the present invention discloses a novel improvement method and database over the parent application.

### SUMMARY OF THE INVENTION

An object of the present invention is to provide an improved telephone number inquiry method and a database for all residents.

To achieve the above object, the present invention discloses a telephone number inquiry method and a database for all residents characterized in that a first object of the database further comprises a third name of second objects and that the third name can be inquired.

To achieve the above object, the present invention discloses a telephone number inquiry database for all residents characterized in that a first object of the database further comprises a third name of second objects.

By the above-mentioned inquiry method and database, contents of the third name can be employer name or superior company name of the one registered in the second name. Consequently, in addition to family information as disclosed in the parent application, information such as employer name, names of employer's subordinates, colleague name and extension numbers thereof, and names of affiliated companies of any third party can be inquired.

The foregoing and other objects, advantages and ways of accomplishing the present invention will become clearer by reference to the following detailed description when taken in conjunction with the following drawings.

### BRIEF DESCRIPTION OF THE DRAWINGS

FIG. 1 is a schematic diagram of a database structure according to a preferred embodiment of the present invention.

FIG. 2 depicts an inquiry method according to the database shown in FIG. 1.

### DETAILED DESCRIPTION OF THE PREFERRED EMBODIMNETS

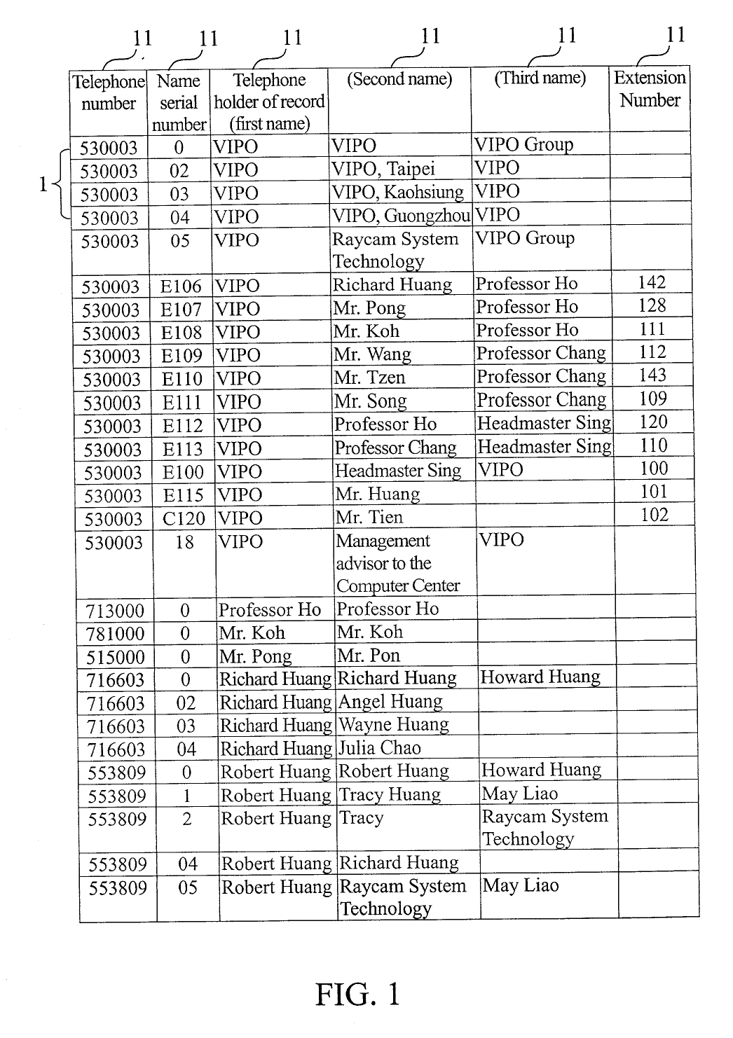

FIG. 1 illustrates a database structure according to a preferred embodiment of the present invention. As shown in FIG. 1, the database of the present invention includes a plurality of first objects 1, each of which further includes a plurality of second objects 11. In the plurality of second objects 11, at least two second objects 11 serve as primary key in representative of the first objects, such as telephone number and name serial number, and part of the other second objects 11 serve as the secondary key of the first objects.

In the parent application, a second name is disclosed and family members are exemplified as the content of the second name. By introducing the second name, all related telephone numbers of both first names (telephone number holder of record) and second names (related parties of the telephone number holder of record), such as family, company, family of parents' house of a married woman, and hometown, can be inquired. Each one of the family or related party can be inquired and contacted this way. The content in the second name is equivalent to the name of the individual or employee, while content in the first name corresponds to the representative party of the family or group (company) with which the individual (employee) is associated.

In the present invention, a third name that belongs to the second objects 11 is further included in the first object 1. The third name records the representative party of an individual (employee) or affiliated company name (subordinate member) as contained in the second name, such as employer name or superior company name.

As illustrated in FIG. 1, the present embodiment gives an example of a community relationship within a company. The third name can be the employer name of the individual (employee) registered in the second name. Similarly, the third name can be the name of the superior company, such as the associated enterprise group if the content in the second name is the name of subsidiary company. Through the incorporation of the third name, it will be as disclosed in the parent application that via a 094 inquiry system the associated group and the telephone numbers of various locations can be inquired. As shown in the database structure of FIG. 1, the representative party of the associated sub-group can also be shown, such as names of employer or superior company. Afterwards names of other related members or companies and telephone numbers that are related to the parties in the second name or the third name can be inquired through the following inquiry method.

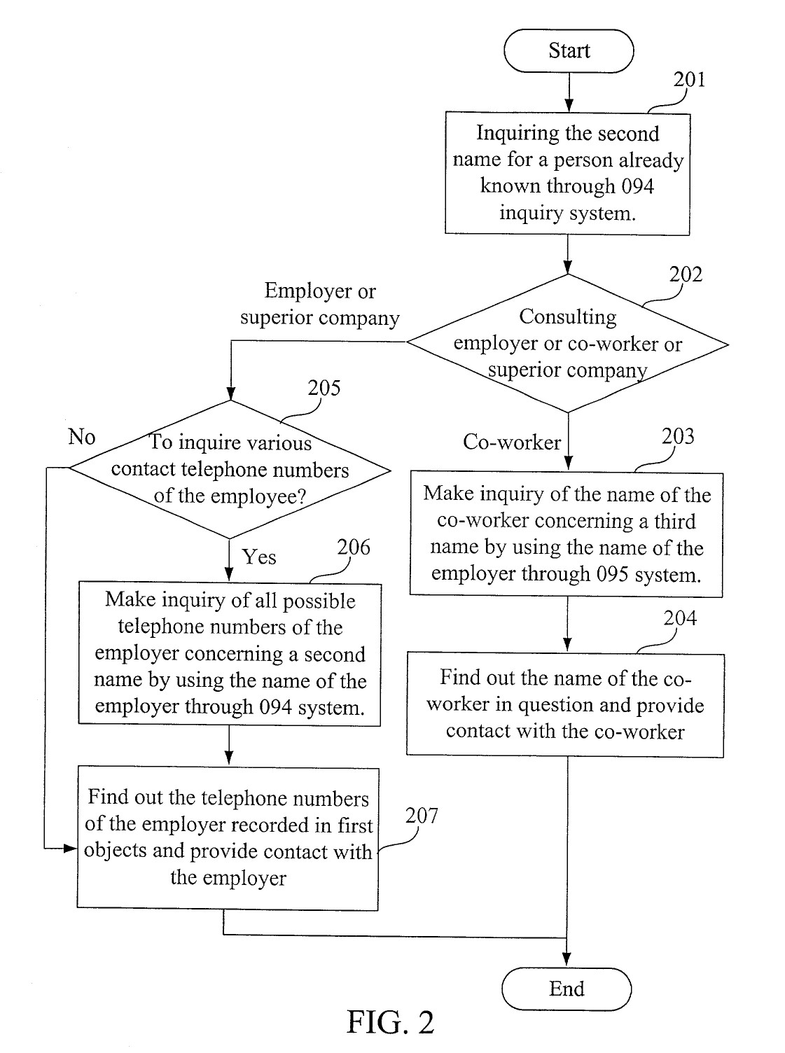

FIG. 2 displays an inquiry method for inquiring names of related members or associated companies according to the database and telephone inquiry method for all residents of the present invention. First of all, in step 201, through a representative number like 094 (corresponding to an inquiry station 104 system in the Republic of China), inquiry is made according to a name of an individual or company already known (as recorded in the second name) to find the telephone number of name or other related telephone numbers, and through which the relevant name of a representative party of the associated main group (content of a first name) and sub-group (content of a third name), such as name of company employer or names of superior or subordinate affiliated company, can be shown. Next, in step 202, judgement is made concerning whether to inquire employer or co-worker of any person or name of the superior company of the subsidiary company. If the person intended for inquiry is employer of the person or the superior company of the subsidiary company, it will enter step 205, or step 203 if it is a co-worker.

In the step 203, through a representative number like 095, inquiry is made according to a third name as the secondary key concerning employer name or name of the superior company and, hence, all first objects that are related to the employer or the superior company are shown. In step 204, in the content of the second name in all the first objects that are related to the employer or the superior company another person or member of the subsidiary company, choose that is different from the known one. Contact can be made through the telephone number in first objects or the extension number in second objects to that the person is related

In the step 205, judgement is made as regards whether to inquire all possible telephone numbers of the employer or the superior company. If negative, it enters step 207 to proceed contact directly with the relevant telephone number in existent first objects. If affirmative, it enters step 206 to inquire all relevant telephone numbers via the 094 inquiry system using the employer name or superior company name based on second objects as inquiry targets, and then proceeds to the step 207 to make contact via the selected telephone number.

In summary, the telephone number inquiry method and database for all residents of the present invention is further improved over the parent application by adding in first objects 1 a third name that is related in any way to the individual (employee) or subsidiary company in second objects that shares the same telephone number to provide recording, for instance, names of the superior, superior company or ancestor of the previous generation. Moreover, in all the inquiry systems mentioned above, while inquiries are made by using the singular second object of second name or third name, if the first objects contain area codes of second objects, each needs to be jointly applied separately, such as the secondary key or making inquiry, as described in the parent applicaiton.

Although only a few preferred embodiments of the present invention have been described in detail herein, it should be understood that the present invention may be embodied in many other specific forms without departing from the spirit or scope of the invention. Therefore, the present examples and embodiments are to be considered as illustrative and not restrictive, and the invention is not to be limited to the details therein, but may be modified within the scope of the following claims.

What is claimed is:

1. A telephone number inquiry database for all residents, providing an inquiry for related information of a person who is a telephone number holder and have a first name, the database comprising a plurality of first objects, each first object including a plurality of second objects, wherein at least two of the second objects serve as a primary key which is not duplicable of each of the first object, a part of the other second objects serve as a duplicable secondary key, and each of the second object includes a second and a third name that share the same telephone number.

2. The database of claim 1, wherein the third name is an employer name of the second name.

3. The database of claim 1, wherein the third name is a superior company name of the second name.

4. The database of claim 1, wherein the second name is a related company name of an enterprise group.

5. The database of claim 1, wherein the second name is an employee name.

6. The database of claim 1, wherein the third name serves as a secondary key.

7. The database of claim 1, wherein the secondary key comprises an area code belonging to the second objects.

8. A telephone number inquiry method for all residents, which uses the database of claim 1, comprising the following steps:
a) an inquirer calling to a telephone number inquiry station;
b) the inquirer giving the inquiry station a name for inquiring; and
c) the inquiry station searching the first objects for the name, finding a conforming first object which includes the name, and reporting the inquirer the telephone number and the third name in the conforming first object for the inquirer to contact.

9. The method of claim 8, further comprising a step of searching for the second names that meet the third name for inquiring all the relevant telephone numbers of the third name after the step c.

10. The method of claim 8, after the step c further comprising a step of searching for the third names that meet the third name to find a relevant second name and for the inquirer to contact the person of the relevant second name.
